(19) United States
(12) Patent Application Publication
(10) Pub. No.: US 2023/0144776 A1
(43) Pub. Date: May 11, 2023

(54) SYSTAINER SYSTEM FOR ELECTRIC STRINGED INSTRUMENTS

(71) Applicant: Willert Howard Lynn, III, Rincon, GA (US)

(72) Inventor: Willert Howard Lynn, III, Rincon, GA (US)

(21) Appl. No.: 17/523,894

(22) Filed: Nov. 10, 2021

(51) Int. Cl. G10H 3/18

(52) U.S. Cl. CPC G10H 3/186; G10H 3/185; G10H 3/181; G10H 3/182; G10H 2210/201; G10H 2230/035

(57) ABSTRACT

A simple yet effective sustainer for electronic stringed instruments having a bridge pickup and a neck pickup. A driver assembly, disposed adjacent the neck pickup of the instrument, includes a plurality of electromagnetic transducers operative to induce vibrations in the strings. A battery-operated electronic amplifier has an input adapted for connection to the bridge pickup, and an output connected to the driver assembly, such that, when the instrument is played, string vibrations sensed by the bridge pickup are amplified by the electronic amplifier and used to drive the driver assembly, thereby sustaining the played string vibrations. The driver assembly may be disposed in a ring that surrounds the neck pickup of the instrument. The ring may include an ON/OFF switch that routes power from the battery to the electronic amplifier and simultaneously deactivates the bridge pickup in the ON position. The ring may further include a phase reversal switch.

### FIELD OF THE INVENTION

This invention relates generally to electronic sustainers and, in particular, to a sustainer that may be added to an electronic guitar with minimal modification.

### BACKGROUND OF THE INVENTION

A “sustainer” is a device that amplifies the string vibrations of a musical instrument to keep the strings vibrating after the instrument is played. The effect can be generated with an ordinary electric guitar if the instrument is played in close proximity to the speaker of an audio amplifier. The acoustic energy caused by the original notes is fed back to the strings through the speaker, prolonging the original vibrations. For this technique to be effective, however, the sound must be very loud.

To avoid such high levels of amplification, instead of bringing the instrument close to the amplifier, the speaker can instead be brought close to the strings of the instrument. In fact, some early systems used a loudspeaker mounted on the instrument in close proximity to the strings. As described in U.S. Pat. No. 4,245,540, the amplified signal from the pickup is passed to the loudspeaker, so that acoustic vibrations produced by the loudspeaker impinge directly upon the strings.

As the output of a loudspeaker can be difficult to control, more modern sustainers use electromechanical transducers instead of speakers, but the idea is nevertheless the same: the string vibrations are amplified and used to drive the transducer, which causes the strings to keep ringing. Now there are sustainer devices that are hand held by the performer, devices that attach to existing instruments, and devices integrated into factory models. But in each case, the solutions are unnecessarily complex and expensive and/or less effective or versatile than they could be.

### SUMMARY OF THE INVENTION

This invention improves upon the existing art by providing a simple yet effective sustainer for electronic stringed instruments, notably electronic guitars. While the system may be factory installed, the system is readily incorporated into an existing instrument with minimal modification.

The sustainer system is ideally suited to an electric stringed instrument having a bridge pickup and a neck pickup. A driver assembly, disposed adjacent the neck pickup of the instrument, includes a plurality of electromagnetic transducers operative to induce vibrations in the strings. A battery-operated electronic amplifier has an input adapted for connection to the bridge pickup, and an output connected to the driver assembly, such that, when the instrument is played, string vibrations sensed by the bridge pickup are amplified by the electronic amplifier and used to drive the driver assembly, thereby sustaining the played string vibrations.

The driver assembly includes a housing configured to receive a row of magnetic pole pieces, each pole piece being supported below a respective one of the strings of the instrument, with a coil of wire wrapped around the housing and the magnetic pole pieces. The output of the electronic amplifier is connected to the coil of wire.

In the preferred embodiment, the driver assembly is disposed in a ring that surrounds the neck pickup of the instrument. The ring may include an ON/OFF switch that routes power from the battery to the electronic amplifier and simultaneously deactivates the bridge pickup in the ON position. The ring may further include a switch that reverses the flow of current through the coil of wire wrapped around the housing and the magnetic pole pieces.

The magnetic pole pieces are preferably threaded into the housing, enabling a user to adjusted the distance between the pole pieces and the strings. The magnetic pole pieces may be composed of a permanent magnet and a magnetizeable member. The ring may be provided in multiple sizes, including a smaller size configured to surround a single-coil pickup and a larger size configured to surround a double-coil hum-cancelling pickup.

The electronic amplifier is preferably an audio amplifier based upon a monolithic operational amplifier, and the amplifier and battery may be disposed in a compartment within the instrument, accessible through back panel, for example.

Different signal and power switching options are disclosed using toggle, blade or other types of switches, including 2-way configurations (to select either bridge or neck pickup), as well as 3-way configurations (to select bridge, bridge and neck, or neck only). In all embodiments, however, the sustainer amplifier circuit is powered only when the neck pickup is deselected.

### BRIEF DESCRIPTION OF THE DRAWINGS

FIG. 1 is a perspective view providing an overview of the invention;

FIG. 2A is an exploded view showing the driver removed from a ring surrounding the neck pickup;

FIG. 2B is an underside, perspective view of a sustainer ring with components installed but not yet mounted on an instrument;

FIG. 3 is a block diagram showing electrical connections and switching functionality;

FIG. 4A is an exploded view of an unassembled driver assembly;

FIG. 4B is an assembled view of a driver assembly;

FIG. 5 illustrates a magnetized driver pole assembly;

FIG. 6 is a schematic diagram of an amplifier circuit applicable to the invention;

FIG. 7 is a block diagram used to illustrate how different switches may be used to route power to a sustainer circuit; and

FIG. 8 depicts a further embodiment utilizing a multi-position pickup-selection switch eliminating the need for neck pickup deactivation on the sustainer ring.

### DETAILED DESCRIPTION OF THE PREFERRED EMBODIMENTS

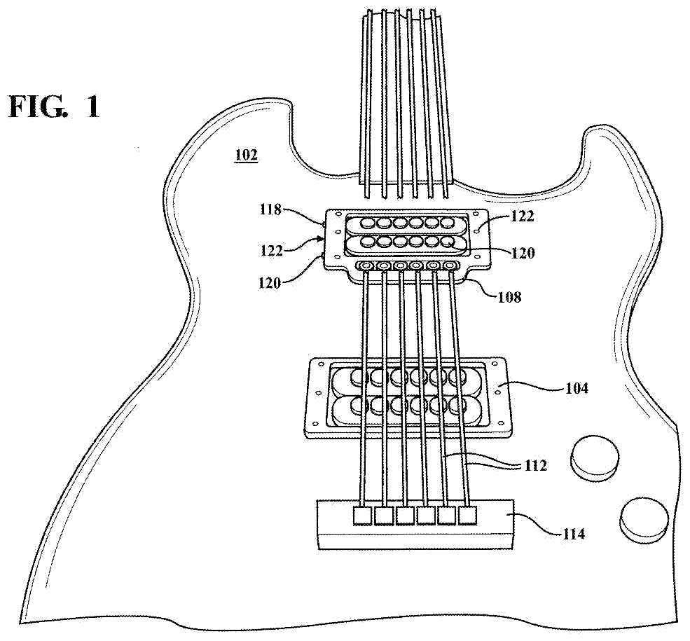

Now making reference to the accompanying drawings, FIG. 1 is a perspective view providing an overview of the invention installed on a 6-string electric guitar 102, with the understanding that the invention is equally applicable to other types guitars and stringed instruments with more or fewer strings. In broad and general terms, an electrical signal from the bridge pickup 104 is amplified by an electronic circuit 106, and the amplified signal is delivered to a driver 108 proximate to neck pickup 110. As strings 112 connected to bridge 114 vibrate, the electronically amplified vibrations are delivered to driver 108, sustaining the vibrations for an extended period of time, in some cases indefinitely depending upon the strength of the original vibrations and other factors.

While in FIG. 1 the driver is shown proximate to a double-coil humbucker type pickup, the invention is equally applicable to single-coil pickups. In the preferred embodiments, the driver 108 forms part of a ring structure 116 that surrounds the neck pickup. A smaller ring 116 than the one shown would be used for single-coil pickups. The ring, which may be constructed from plastic, provides two switches, including an ON/OFF switch 118 and a phase-reversing switch 120. While the phase reversal function may be eliminated, it is provided in the preferred embodiment for more versatile sound effects. Though not visible in FIG. 1, when the unit is turned ON, an LED 122 is illuminated.

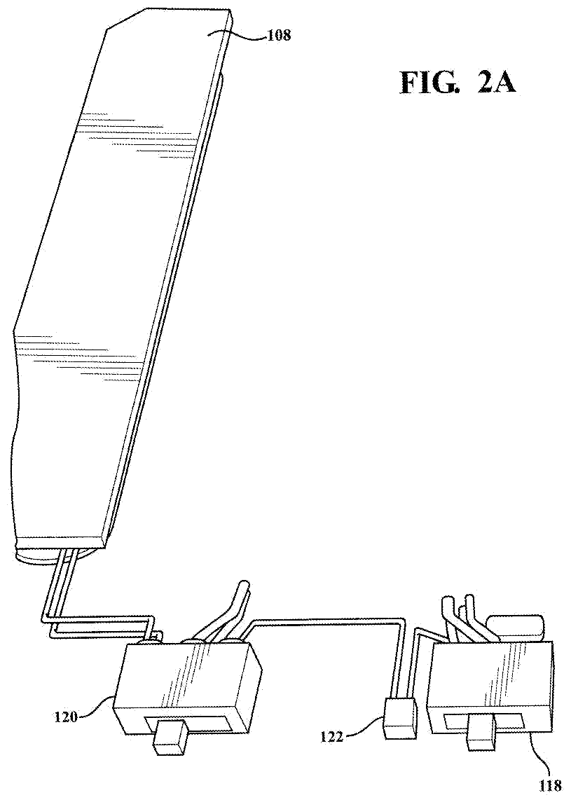

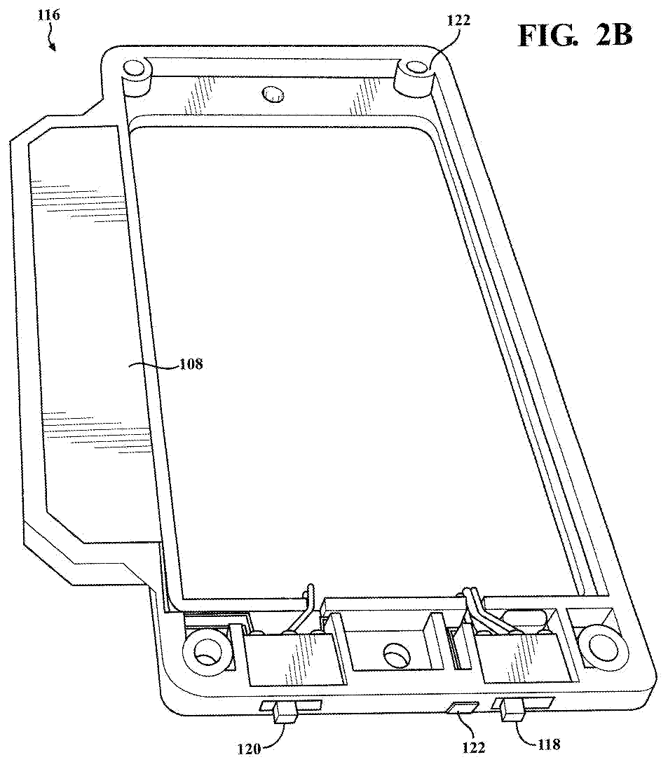

FIG. 2A is an exploded view showing the driver 108 removed from ring 116 viewed from the backside of the ring. Both switches 118, 120 are double-pole, double-throw (DPDT) switches, the wiring of which is best seen in FIG. 3. ON/OFF switch 118 provides three functions. First, it routes power to the amplifier, and second, it provides power to the LED. But perhaps most importantly, in the ON position, power switch 118 disconnects the neck pickup. With the driver 108 being so close to the neck pickup, if the neck pickup remained ON during sustain the feedback would be too strong to provide reliable results.

FIG. 3 is a block diagram showing electrical connections and switching functionality. When power switch 118 is in the ON position, one pole of the switch disconnects the neck pickup from line 302 to other connections within the guitar to volume controls, etc. The other pole of the switch 118 connects power (V+) to amplifier 400 and LED 122 through current-limiting resistor 124. Note that V+ in this case is derived from a battery disposed along with amplifier 400 in the electronic compartment of the instrument, typically accessible through an access panel on the back of the instrument. The battery may be any operative voltage depending upon the amplifier circuitry described below, such as 5, 9, 12, 15 volts, etc.

While the invention may come factory installed within an instrument, it may also be added to an existing instrument, in which case connections such as A and B in FIG. 3 may be accomplished with soldering, alligator clips, or any other reliable technique. In switch 120, both poles are used simultaneously, such that in the two settings the windings around driver 108 are reversed. Note that FIG. 3 is not to scale, and various aspects of the system are simplified, including the windings around the pickups 110, 114 and driver 108.

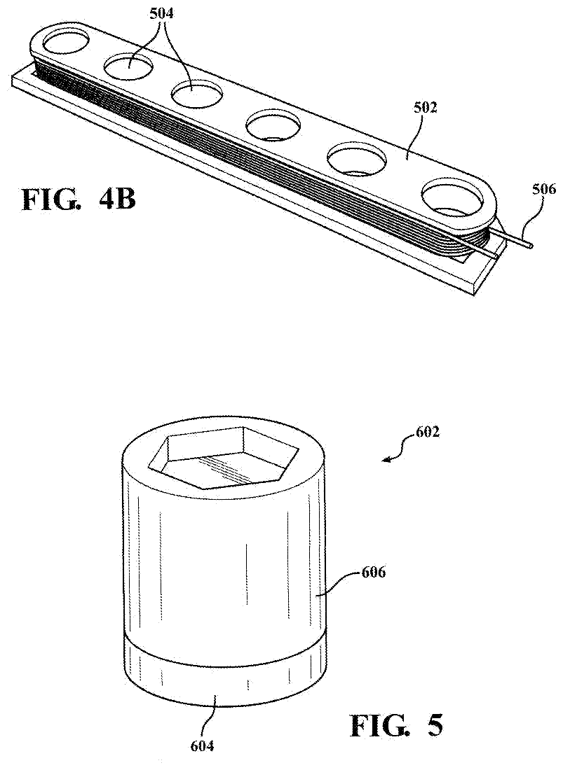

FIG. 6 is a schematic diagram of an amplifier circuit 400 applicable to the invention, with the understanding that while this configuration is operable, other amplifier circuits are possible. As such, the invention is not limited in terms of the specific amplifier arrangement used. In this embodiment, the amplifier 402 is a TDA7267 fully integrated 2-Watt monophonic amplifier using conventional peripheral resistors and capacitors for signal coupling, currently limiting, filtering and so forth.

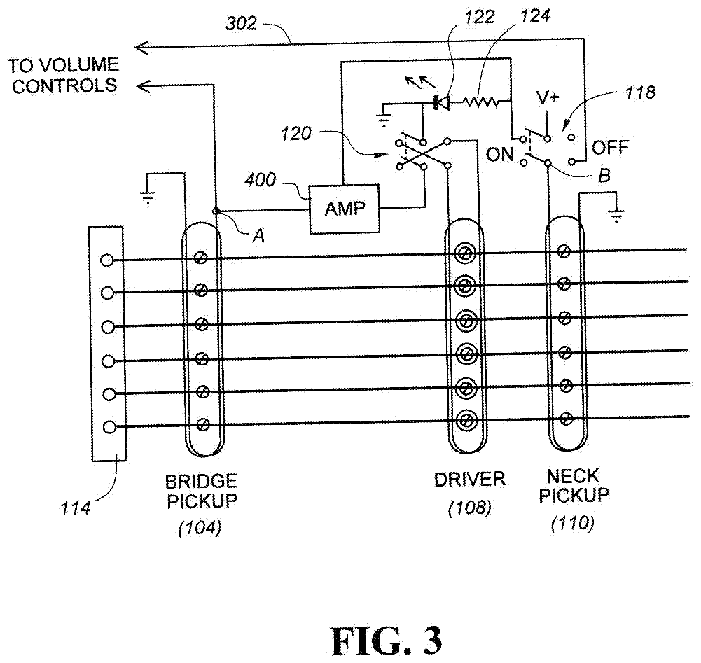

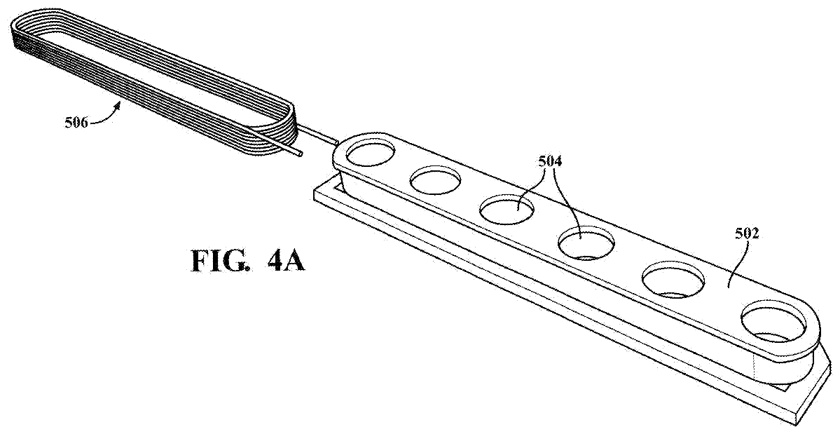

FIGS. 4A, B are detailed diagrams of a driver coil assembly applicable to the invention, including a housing 502 including a plurality of cavities 504 to receive pole assemblies depicted in FIG. 5. The housing 502 may be of any non-conductive material such as molded plastic. A driver coil 506 is wound around the housing 502, resulting in the completed assembly of FIG. 4B. The coil 506 may comprise 50 to 70 turns of 32 AWG insulated copper wire to achieve an impedance of 8 ohms so as to be compatible with the amplifier circuit of FIG. 6. Other numbers of turns and different wire gauges are of course possible depending upon the circuitry ultimately implemented.

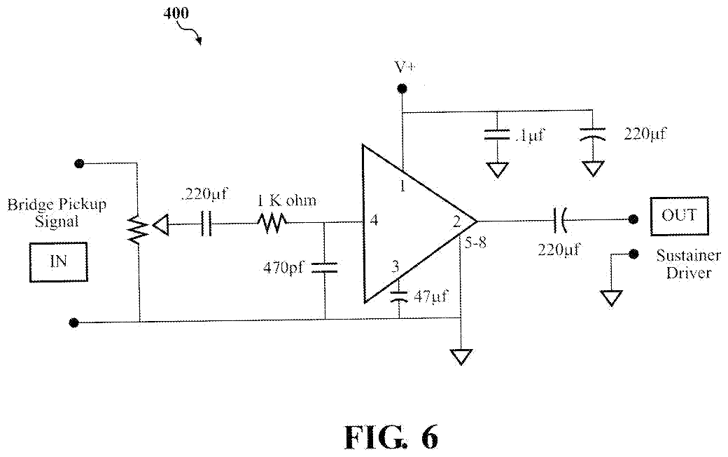

FIG. 5 illustrates a magnetized driver pole assembly 602. Each one of the cavities 504 in FIG. 4A would receive a separate one of the driver pole assemblies 602. Each assembly preferably includes a strong, rare-earth magnet 604 and cylindrical screw 606. Magnet 604 may, for example, comprise an N54 neodymium disc having a height of 1 mm and a diameter of 5 mm. The screw 606 may have a diameter of 6 mm and a height of 4 mm, resulting is an overall driver pole measuring 6 mm wide by 5 mm high. The screw would be constructed of a magnetizeable material such as iron, or a magnetizeable alloy.

Whereas the embodiments thus far described utilize DPDT switches, other types of switches my be used for different pickup selection options, but in all cases, as shown in FIG. 7, power is only routed to the sustainer circuit when the neck pickup is disabled (and the sustainer ring ON/OFF switch is in the ON position if a separate ON/OFF switch is provided).

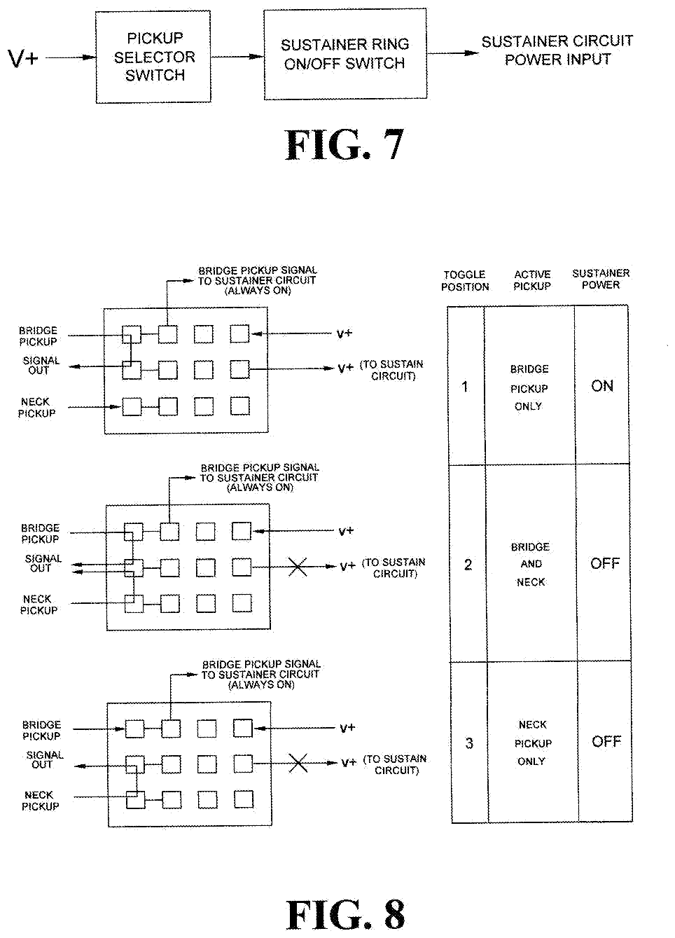

As one example of a different pickup selection arrangement, FIG. 8 illustrates power and signal routing associated with a multi-position pickup-selection switch, in this case a 3-way, 4-pole, ON/ON/ON toggle switch (for example, Part No. SWM43-17 from C&K). It will be further appreciated by those of skill in the art that different-sized toggle switches may be used, including mini-toggle switches, as well as blade-type switches. Note that when such multi-position switches are implemented, the need for a separate ON/OFF switch on the sustainer ring may be obviated.

In all positions of FIG. 8, the bridge pickup signal to the sustainer circuit is always routed to the amplifier circuit regardless of whether the amplifier is powered on. In position 1, only the bridge pickup is selected, and power is indeed routed to the amplifier, and sustainer functionality is activated. In positions 2, 3 however, the neck pickup is selected, and power to the amplifier is disabled, thereby defeating sustainer functionality.

1. A sustainer system for an electric stringed instrument having a bridge pickup and a neck pickup, the sustainer comprising:
a driver assembly disposed adjacent the neck pickup of the instrument, the driver assembly including a plurality of electromagnetic transducers operative to induce vibrations in the strings;
a battery-operated electronic amplifier having an input and an output, the input to the amplifier being adapted for connection to the bridge pickup, with the output of the amplifier being connected to the driver assembly;
wherein, when the instrument is played, string vibrations sensed by the bridge pickup are amplified by the electronic amplifier and used to drive the driver assembly, thereby sustaining the played string vibrations; and
a switch operative to disable the neck pickup when the electronic amplifier is powered on.

2. The sustainer system of claim 1, wherein:
the driver assembly includes a housing configured to receive a row of magnetic pole pieces, each pole piece being supported below a respective one of the strings of the instrument;
a coil of wire wrapped around the housing and the magnetic pole pieces; and
wherein the output of the electronic amplifier is connected to the coil of wire.

3. The sustainer system of claim 2, wherein the driver assembly is disposed in a ring that surrounds the neck pickup of the instrument.

4. The sustainer system of claim 3, wherein the switch is an ON/OFF switch disposed in the ring that simultaneously deactivates the neck pickup and routes power from a battery to the electronic amplifier.

5. The sustainer system of claim 1, further including a multi-position pickup selection switch that (a) chooses between the neck or bridge pickup, and (b) routes power battery to the electronic amplifier only when the neck pickup is not selected.

6. The sustainer system of claim 5, wherein the multi-position pickup selection switch including three positions, including a first position wherein only the bridge pickup is selected, a second position wherein the bridge and neck pickup are both selected, and a third position whereon only the neck pick is selected; and
wherein power battery is routed only to the electronic amplifier when the switch is in the first position.

7. The sustainer system of claim 7, wherein the multi-position pickup selection switch is a toggle stitch or blade switch.

8. The sustainer system of claim 3, wherein the ring further includes a switch that reverses the flow of current through the coil of wire wrapped around the housing and the magnetic pole pieces.

9. The sustainer system of claim 2, wherein the magnetic pole pieces are threaded into the housing enabling a user to adjusted the distance between the pole pieces and the strings.

10. The sustainer system of claim 2, wherein the magnetic pole pieces are composed of a permanent magnet and a magnetizeable member.

11. The sustainer system of claim 3, wherein the ring is provided in multiple sizes, including a smaller size configured to surround a single-coil pickup and a larger size configured to surround a double-coil hum-cancelling pickup.

12. The sustainer system of claim 1, wherein the electronic amplifier is an audio amplifier based upon a monolithic operational amplifier.

13. The sustainer system of claim 1, wherein the amplifier and battery are disposed in a compartment within an electronic guitar.
